(19) United States
(12) Patent Application Publication
(10) Pub. No.: US 2008/0155319 A1
(43) Pub. Date: Jun. 26, 2008

(54) Methods and systems for managing removable media

(76) Inventors: Robert Duncan, North Grafton, MA (US); John Czerkowicz, Northborough, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/589,544

(22) Filed: Oct. 28, 2006

(51) Int. Cl. G06F 11/00

(52) U.S. Cl. 714/13

(57) ABSTRACT

Embodiments include methods, apparatus, and systems for managing removable media. One embodiment includes a tape drive having a non-volatile memory storing media management records that uniquely identify a tape cartridge containing current data for restoring a failed computer system, wherein the tape drive is an external peripheral device to the computer system.

### BACKGROUND

Computer systems use software applications that backup data onto removable storage media. The backup data enables the computer system to be restored in the event of a failure. If the computer system crashes, for example due to a hard drive failure, then all data resident on the computer system is lost. The removable media is used to restore the computer system to its original state before the crash.

When such a failure occurs, recovering the data from the removable media can be a difficult task. Computer systems are often regularly backed up, so different versions of the data may exist on numerous copies of removable media. Finding the correct copy of the most current data can be time consuming and tedious. This process can include reviewing the data on each removable media until the correct version is discovered.

If a single peripheral drive is used to backup files for multiple computer systems, the number of different removable media increases. This increased volume of media can add to the difficulty and time in determining the correct data for restoring the computer system to its pre-crash state.

In addition, since each computer system maintains a separate backup database, multiple computer systems cannot share rewritable media. A backup application running on one computer system only has knowledge of backup jobs and media content related to that particular computer system. The application is unaware of critical information from another computer system that can exist on shared removable media. As such, critical data can be unintentionally overwritten.

### BRIEF DESCRIPTION OF THE DRAWINGS

FIG. 1 is a block diagram of a removable media management system in accordance with an exemplary embodiment of the present invention.

FIG. 2 is a flow diagram for managing removable media in accordance with an exemplary embodiment of the present invention.

FIG. 3A is a block diagram of a system for managing removable media in accordance with an exemplary embodiment of the present invention.

FIG. 3B is a block diagram of a system for managing removable media in accordance with an exemplary embodiment of the present invention.

FIG. 3C is a block diagram of a system for managing removable media in accordance with an exemplary embodiment of the present invention.

### DETAILED DESCRIPTION

Embodiments in accordance with the present invention are directed to apparatus, systems, and methods for managing removable media. One embodiment provides a fixed storage area within a removable and portable external media drive and provides an extension of a backup software application to access data in this storage area. The backup application creates an additional copy of its media management records in the storage area of the media drive. Following a complete or partial loss of data on a computer system, the backup application references the media management records stored in the media drive in order to determine which removable media are needed to recover the computer system.

When a software application backs up data onto removable media, the application creates a media management record. This record contains information (example, metadata) about the backup, such as media used, time and date of backup, description of data copied, etc. This information is stored in three separate locations: the computer system, the removable media, and the media drive. Thus, if the computer system fails (example, from a hard drive crash or complete system failure), information concerning backups and current data on the computer system is obtainable from the media drive. For example, during data recovery, the media drive is used to notify a user which removable media should be used to recover selected files.

With embodiments in accordance with the invention, finding the correct copy of the most current data after a system failure is quick and easy. Users are not required to review each removable media for selected files. Instead, the media drive includes a list of each removable media used by the media drive, each system backed up by the media drive, and each backup operation performed on each removable media. For example, if a single peripheral media drive is used to backup files for multiple computer systems, the media drive stores records for each of the removable media associated with each of the multiple computer systems and records of the corresponding backup operations.

In one embodiment, the media drive maintains a separate backup database or storage area for each of multiple computer systems. A backup application running on one computer system only has knowledge of backup jobs and media content related to that particular computer system. At the same time, however, the media drive has knowledge of backup jobs for all of the computer systems. The media drive is aware of critical information from different or separate computer systems. As such, critical data will not be unintentionally overwritten during a recovery of one of the computer systems since the media drive maintains an inventory of media management records for each computer system.

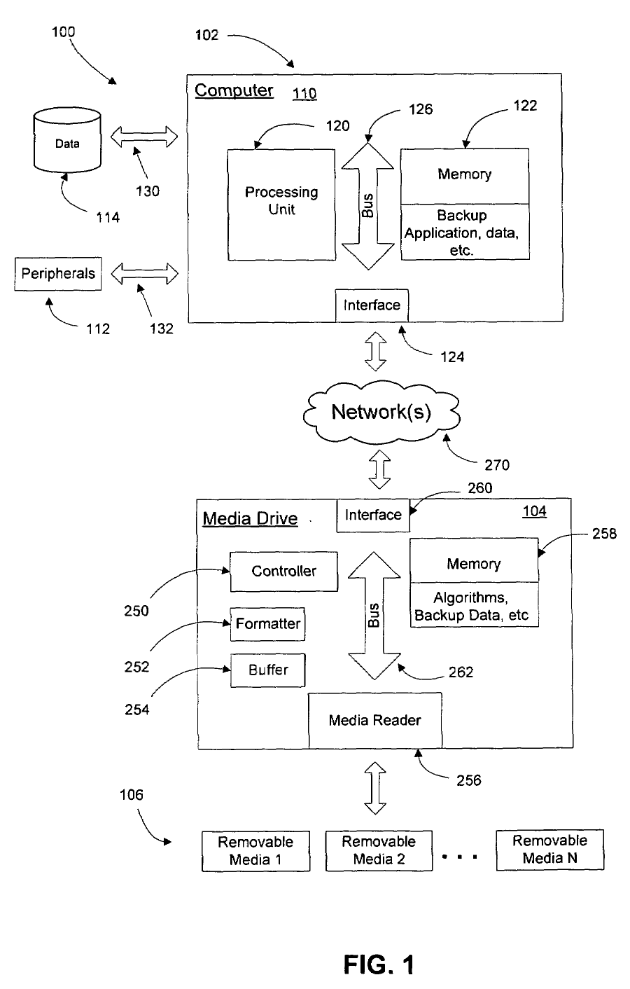

FIG. 1 shows a system 100 for managing removable media. The system includes a computer system 102, a media drive 104, and one or more removable media 106. The computer system 102 includes a computer 110 (such as a host or client computer), one or more peripherals 112 and a repository, warehouse, or database 114. The computer system 102 comprises a processing unit 120 (such as one or more processors of central processing units, CPUs), memory 122, interface 124, and buses 126. The processing unit 102 controls the overall operation of memory 122 (such as random access memory (RAM) for temporary data storage and read only memory (ROM) for permanent data storage). The memory 122, for example, stores applications (such as a data backup application for the media drive 104), data, control programs, algorithms (including software to implement or assist in implementing embodiments in accordance with the present invention), and other data associated with the computer system 102. The processing unit 120 communicates with memory 122, interface 124, etc. via buses 126.

Communication links 130/132 provide communication pathway between the computer system 102 and the database 114 and peripherals 112. By way of example, the peripherals include, but are not limited to, one or more of drives (such as CD or DVD drives), printers, mouse, monitor, keyboard, scanner, etc.

As used herein, a “media drive” is an electronic device that reads and/or writes data to removable media. By way of example, media drive 104 includes, but is not limited to, one or more of rewritable and WORM disk drives (such as an optical drive for reading/writing to CDs, CD-ROMs, DVD, etc.), removable magnetic disk drives, floppy drives, and tape drives. For illustration, media drive 104 is described as a tape drive.

As shown, media drive 104 includes a controller 250, a formatter 252, a buffer 254, a media reader 256, memory 258, an interface 260, and one or more busses 262. The controller 250 controls the overall operation of the media drive 104 (such as reading and writing data to removable media and storing and retrieving data in memory 258). The buffer 254 is a memory for locally buffering blocks of data read from and written to removable media while in the media reader 256. Data is formatted into blocks with the formatter and communicated through bus 262 to interface 260.

Memory 258 broadly includes one or more of RAM, ROM, etc. The media drive also includes firmware in the form of code and/or application specific integrated circuits (ASIC) contains algorithms for converting block sizes of data. Further, the memory 258 can store applications, data, control programs, algorithms (including software to implement or assist in implementing embodiments in accordance with the present invention), and other data associated with the computer system 102 or media drive 104.

In one exemplary embodiment, memory 258 includes non-volatile computer memory that can be electronically erased and reprogrammed, such as flash memory. This memory stores record information associated with reads and writes to the removable media 106.

Media drive 104 also includes a media reader 256 for reading and writing data to removable media 106. For tape drives, media drive 104 includes a tape drive mechanism removably receiving media 106, a set of read/write heads, etc. In one exemplary embodiment, the removable media 106 include, but are not limited to, magnetic tapes, digital data storage (DDS) tapes, digital linear tape (DLT and SuperDLT), tapes using linear tape open (LTO), VXA packet tape technology, or any other known portable and removable tape devices.

The computer system 102 and media drive 104 communicate through a direct coupling or through one or more networks 270. For instance, the media drive 104 communicates with the computer 110 using a small computer system interface (SCSI) or other interface. Further, by way of example, network 270 includes one or more of the internet, local area network (LAN), wide area network (WAN), etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

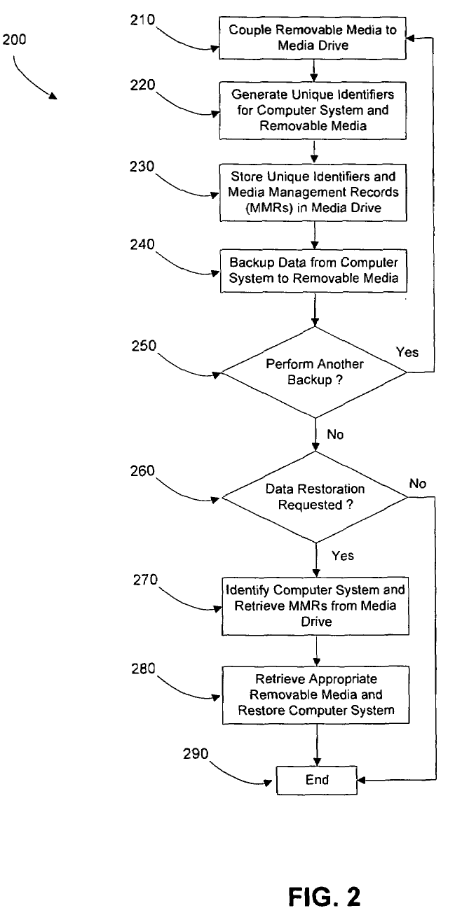

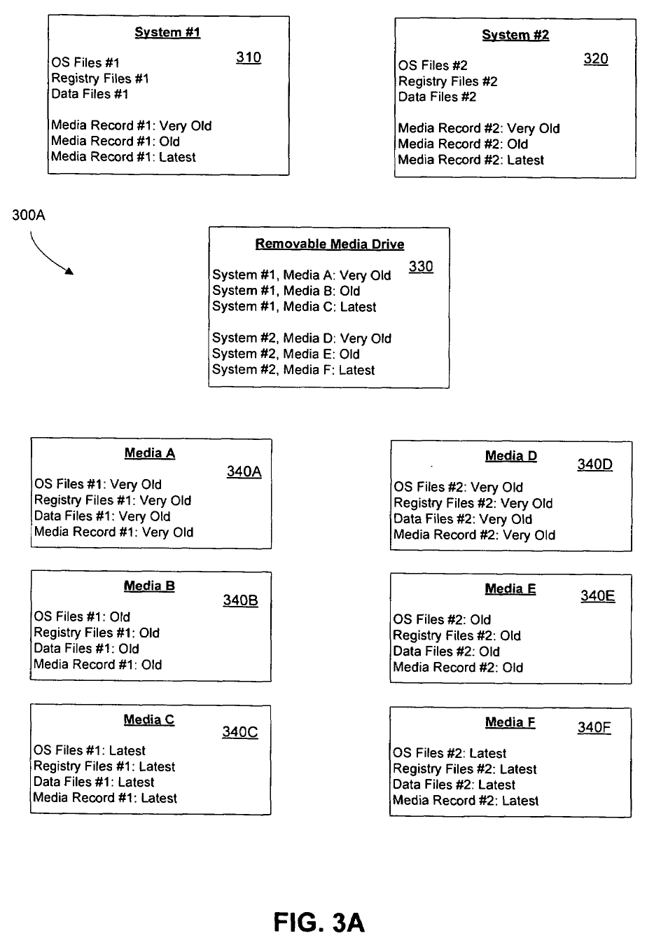

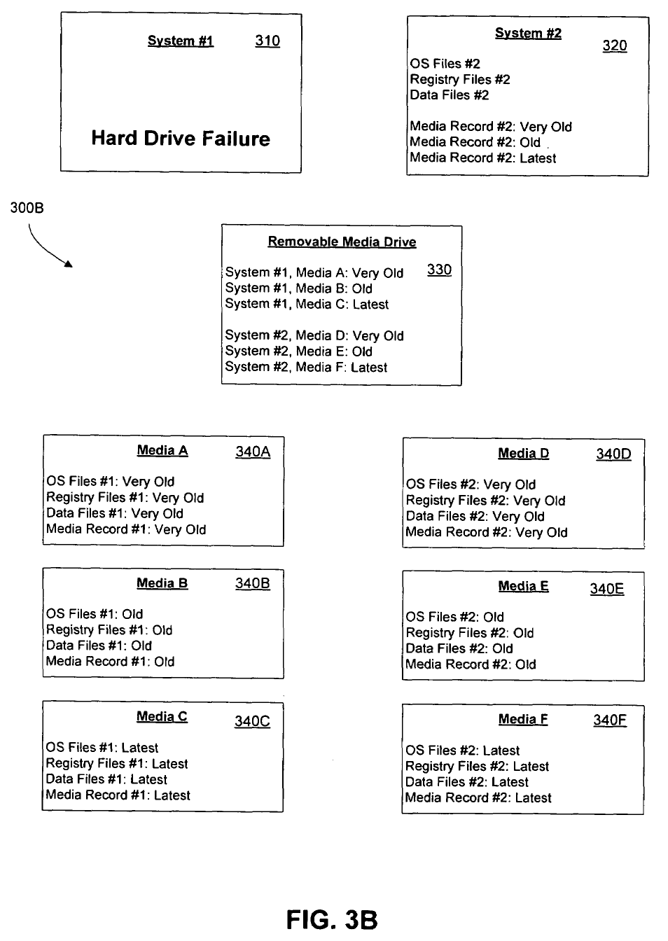

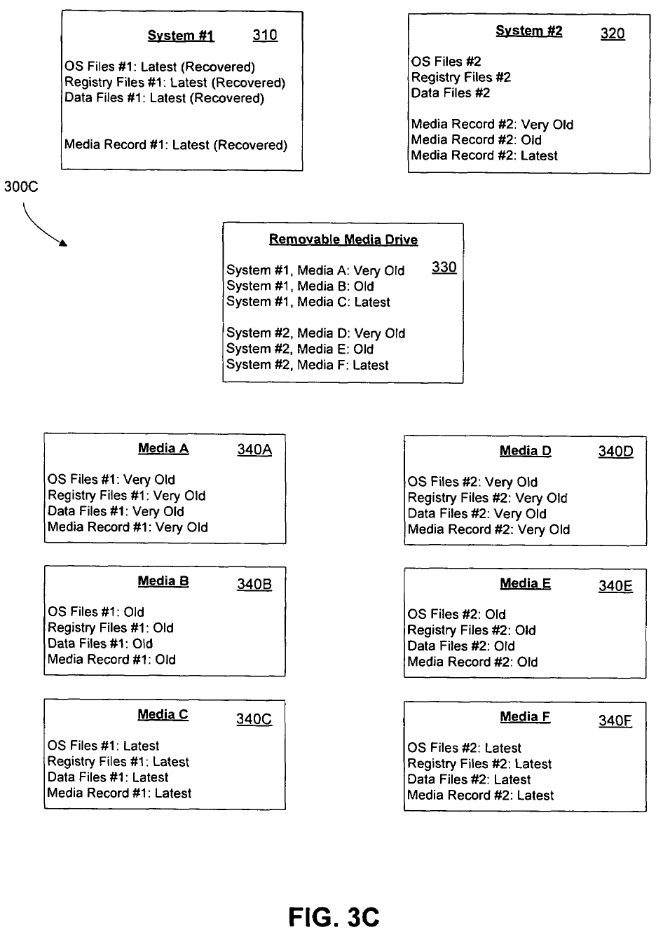

FIG. 2 is a flow diagram 200 for managing removable media in accordance with an exemplary embodiment of the present invention. This flow diagram is discussed in connection with FIGS. 3A-3C which illustrate block diagrams for an exemplary system experiencing complete loss of data and subsequent data restoration.

According to block 210, removable media is coupled to the media drive. In one exemplary embodiment, the removable media is handheld portable magnetic tapes, optical disks, or other type of portable storage media. The media drive is a peripheral device that is external to the computer system. By way of example, the media drive is a standalone portable drive (such as a tape drive, optical drive, etc.) that is separate from or external to the computer system.

According to block 220, unique identifiers are generated for both the computer system and the removable media. In one exemplary embodiment, the backup application generates a unique identification for the system and media. For example, the system is uniquely identified using a hashing function to generate a signature based on system hardware information. Such system information includes, but is not limited to, one or more of media access control (MAC) address, data link control (DLC) address, computer system serial number, unique computer name, etc. Further, the removable media is also provided with a unique identification, number, character string, etc. For example, a unique serial number is written onto each removable media to uniquely distinguish the removable media from other removable media that may or may not inserted into the media drive.

According to block 230, the generated unique identifiers and media management records (MMRs) are stored in the media drive. This information can also be stored in the computer system and written to the removable media.

Media management records include information associated with the computer system, the removable media, and the backup job. For instance, this information includes time and date of backup, location of backup on removable media, amount of data, and identification of the system, media, and drive. In one exemplary embodiment, this information is metadata that describes how, when, and by whom a particular set of data is collected and formatted.

The media management records and unique identifiers are stored in non-volatile memory within the media drive. For instance, this information is stored in flash memory in the media drive.

According to block 240, data from the computer system is backed up (i.e., copied) to the removable media. In one exemplary embodiment, a backup application provides a user interface for coordinating the backup, and performs other functions, such as formatting, compression, etc.

FIG. 3A shows an information management system 300A that includes multiple computer systems (shown as system 310 and system 320). Each of these systems includes various stored data, such as operating system (OS) files, registry files, data files, etc. Each system also includes each media management records associated with the backup operations performed on the system. By way of illustration, these records are shown chronologically as media record (very old), media record (old), and media record (latest).

The removable media drive 330 stores the media management records for each system. By way of illustration, this information is shown for system #1 as (1) media A: very old, (2) media B: old, and (3) media C: latest. This information is shown for system # 2 as (1) media D: very old, (2) media E: old, and (3) media F: latest.

The number of systems (shown as two different systems), the number of media drives (shown as one), and the number of media (shown as six media A-F) are provided for illustration. Exemplary embodiments are applicable to a much larger or smaller number of systems, media, and drives. Further, the number of removable media depends on the amount of data and the number or frequency of backup operations.

Each respective media (media 340A-media 340F) includes backup data, media management information, and unique identification. By way of illustration, each media includes information corresponding to its respective system as OS files, registry files, data files, media management records, etc.

According to block 250, a question is asked: Does the user desire to perform another backup? If the answer to this question is “yes” then flow proceeds back to block 210. If the answer to this question is “no” then flow proceeds to block 260.

As shown in FIGS. 3A-3C, the media drive stores unique identifiers and media management records for plural different removable media and computer systems. In other words, each computer system can have plural different backup removable media that are used over an extended period of time. The media drive stores this information as a history of all backup operations performed on the media drive with respect to each different computer system and removable media.

According to block 260, a question is asked: Does the user desire to perform a data restoration? If the answer to this question is “no” then flow proceeds to block 290 and flow ends. If the answer to this question is “yes” then flow proceeds to block 270.

According to block 270, the media drive is used to identify the computer system and its history of backups. The media drive provides all of the media management records for a user identified computer system. By way of example, this information is provided to a user as a report, through a graphical user interface, to another computer system, etc. A user can select which data to use for restoration. For instance, a user can select the latest (i.e., most recent in time) files copied in order to restore the computer system to its state prior to the failure.

According to block 280, the appropriate removable media is identified and retrieved in order to restore the computer system or selected files/data of the computer system to a previous point-in-time. By way of illustration, FIG. 3B shows the system 300B after computer system 310 has experienced a complete hard drive failure resulting loss of all OS files, registry files, data files, media management records, etc. After such a failure, a user desires to restore the system 310 back in time to a restoration point.

In one exemplary embodiment, when the backup records are no longer available on the system, the backup application identifies the system that failed and then automatically determines the removable media with the most current files. In order to make this determination, the backup application retrieves the media management information corresponding to the system from the peripheral media drive. As shown in FIG. 3C of system 300C, the restoration information for system 310 is stored in removable media drive 330 as “System #1, Media C: Latest.” Thus, the media drive identifies one or more of the removable media containing the latest data/files to restore the system 310. With this information, a user can select media 340C to restore system 310.

In one exemplary embodiment, the backup application ensures that the correct media is being used for recovery by verifying the unique identifier stored on the removable media. For instance, if the user inserts the correct removable media (example, most recent) into the media drive for recovery, the user is provided with a visual or audible notification that the correct removable media is being used for the restoration. On the other hand, if the user inserts an incorrect version of removable media (example, one with outdated data) into the media drive, then a notification is provided to the user. For instance, the user can be prompted to verify that restoration should proceed with the selected media. The application can also provide a recommendation for using another, more recent, or different version of data from another removable media.

By referencing the information stored in the fixed, non-volatile memory within the peripheral media drive, the backup application prevents overwriting of critical information from a different system. Users will not accidentally overwrite data required for another system to perform disaster recovery. The application also ensures that the proper files are being used for restoration. Thus, data from multiple different, separate computer systems can be backed up or restored by using information stored in a single peripheral media drive.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A tape drive, comprising:
non-volatile memory storing media management records that uniquely identify a tape cartridge containing current data for restoring a failed computer system, wherein the tape drive is an external peripheral device to the computer system.

2) The tape drive of claim 1, wherein the memory further stores a first identifier that uniquely identifies the computer system and a second identifier that uniquely identifies the tape cartridge.

3) The tape drive of claim 1, wherein the memory further stores times and dates of plural separate backup operations for the computer system.

4) The tape drive of claim 1, wherein the memory is flash memory.

5) The tape drive of claim 1, wherein the memory further stores (1) serial numbers for each of plural separate tape cartridges inserted into the tape drive and (2) a unique number generated by a hash function, the unique number identifying the computer system.

6) The tape drive of claim 1, wherein the memory further stores metadata that uniquely identifies plural different tape cartridges inserted into the tape drive over a period of time to backup data stored on the computer system.

7) A method of software execution, comprising:
inserting a portable removable media into an external peripheral media drive;
copying backup data from a computer system through the media drive to the removable media; and
storing metadata on the media drive, the metadata including information that uniquely identifies the removable media and a date of the copying backup data.

8) The method of claim 7 further comprising:
using a function to generate a unique identifier for the computer system;
storing the unique identifier as part of the metadata.

9) The method of claim 7 further comprising:
generating an identifier that uniquely identifies the removable media;
storing the identifier on both the removable media and the media drive;
using the identifier and the date of copying backup data to determine if the removable media includes a most recent version of data for restoring the computer system.

10) The method of claim 7 further comprising:
copying backup data from the computer system to plural removable media over a time period;
storing a date and an identification of a removable media on the media drive each time a backup operation occurs on the media drive;
using information stored in the media drive to determine which of the plural removable media to select for restoring the computer system after a hard drive failure.

11) The method of claim 7 further comprising, using the metadata to prevent a user from accidentally overwriting the backup data on the removable media.

12) The method of claim 7 further comprising, storing the metadata in flash memory in the media drive.

13) The method of claim 7 further comprising:
using a media access control (MAC) address of the computer system to generate a unique identifier for the computer system;
storing the unique identifier on the removable media and with the metadata.

14) The method of claim 7 further comprising, storing new metadata on the media drive each time removable media is coupled to the media drive to backup the computer system, the new metadata including both a date and time when backup data is copied to the removable media.

15) A media drive, comprising:
a controller; and
non-volatile memory coupled to the controller, the memory storing information that includes (1) dates when plural removable media were coupled to the media drive to backup data on one or more of plural computer systems, and (2) identifiers that uniquely identify the plural removable media, the media drive being an external peripheral device to the plural computer systems.

16) The media drive of claim 15, wherein the information further includes (3) identifiers that uniquely identify all computer systems that were coupled to the media drive to backup data onto one or more removable media.

17) The media drive of claim 15, wherein the information further includes (3) an identification of a location on the removable media for data that was copied to the removable media.

18) The media drive of claim 15, wherein the media drive is one of a tape drive or an optical disk drive.

19) The media drive of claim 15, wherein the memory is flash memory.

20) The media drive of claim 15, wherein the media drive writes a unique identifier and time when a backup operation occurs on each removable media inserted into the media drive for a backup operation.
